(19) United States
(12) Patent Application Publication
(10) Pub. No.: US 2016/0379610 A1
(43) Pub. Date: Dec. 29, 2016

(54) ADJUSTABLE LENGTH ACOUSTIC DRUM HARDWARE TENSION ROD

(71) Applicant: Gary T. Albright, Grants Pass, OR (US)

(72) Inventor: Gary T. Albright, Grants Pass, OR (US)

(21) Appl. No.: 15/192,538

(22) Filed: Jun. 24, 2016

Related U.S. Application Data
(60) Provisional application No. 62/184,096, filed on Jun. 24, 2015.

(51) Int. Cl. G10D 13/02

(52) U.S. Cl. CPC G10D 13/023

(57) ABSTRACT

An adjustable length acoustic drum hardware tension rod with a threaded proximal portion and a plurality of threaded distal portions, each of the distal portions separated from an adjoining portion by a “V” type groove or scorings cut into the tension rod at intervals along its length. The grooves provide points of weakness where the rod may be accurately broken and snapped off so as to enable a user to select any of a number of variable lengths appropriate for a specified function. The V-shaped grooves disrupt but do not displace continuous threads so as to enable the rod to be broken off without damaging the threads on the rod. The remaining rod can be used as a threaded male element for a threaded female mounting lug.

### CROSS REFERENCES TO RELATED APPLICATIONS

The present application claims priority to, and the benefit of the filing date of, U.S. Provisional Patent Application Ser. No. 62/184,096, filed Jun. 24, 2015, incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

Field of the Invention

The present invention relates most generally to acoustic percussion musical instruments, and more particularly to drumhead assembly apparatus, and still more particularly to bolting hardware for assembling a conventional drum.

Background Discussion

Drum kits for contemporary musical groups assume a variety of configurations, but many typically include a variety of drum types, including bass drums, snare drums, floor toms, mounted toms (e.g., high and middle toms mounted on a bass drum), timbales, and similar drums (setting aside other percussion instruments not comprising drums, e.g., cowbells, cymbals, and the like, as well as the support and stand hardware). The drums include a cylindrical drum shell with open ends and a drumhead tightly stretched over at least the upper open end (generally referred to as the “batter” head). If a second drumhead is included, it is disposed over the open bottom end and is referred to as the “resonant” head.

Drumhead(s) are disposed over the bearing edges of the shell circumscribing an open end. High quality sound—pitch and timbre—in the instrument depends on establishing and maintaining proper tension in at least the batter drumhead, and when two drum head are use, in establishing and maintaining the proper tension in each head, and thus the relationship between the two heads. Accordingly, acoustic drums include a tensioning system to provide means to adjust the tension in each of the drumheads. Tensioning apparatus includes the rim or hoop that is disposed over the drumhead on the open end, the hoop being rigid and including multiple spaced tabs having through holes, each for passing a threaded tension rod that threadably inserts into a mounting lug or tension rod casing attached to outer surface of the shell. The tension rods are tightened relatively uniformly with controlled torques to urge the hoops down onto the bearing surface and thereby to stretch the drumhead into the desired tension.

Tension rods are thus a critical component in multiple tension rod assemblies, and the length needed for tension rods varies according to the location of the mounting lug or tension rod casing. When constructing drum or when carrying a drum tension rod inventory for performances, it would be convenient to have a limited inventory to meet the needs of all drums in a typical kit, those calling for the use of long tension rods and those calling for the use of shorter tension rods. This need is as yet unmet.

### BRIEF SUMMARY OF THE INVENTION

The present invention is an adjustable length acoustic drum hardware tension rod. The fully threaded rod contains “V” type grooves (or scorings) shaped and cut into the rod at predetermined intervals along its length. The grooves provide points of weakness where the rod may be accurately broken and snapped off so as to enable a user to select any of a number of variable lengths appropriate for a specified function. The V-shaped grooves disrupt what would otherwise be continuous threads with the groove space simply constituting a gap in the helical thread, and the grooves enable the rod to be broken off without damaging the threads on the rod; thus, the remaining rod can be used as a threaded male element for a threaded female receiver. This contrasts with typical threaded rods, which, when broken off or snapped off, have distorted or otherwise damaged threads as a result of the breakage, and can not be readily used or when used cause damage to a corresponding mounting lug or tension rod casing or receiver.

Objects of the invention include providing a single tension rod that is adjustable in its length so that it will fit on a large variety of drum hardware configurations.

Another object of the present invention is to provide a single tension rod that eliminates the need for tensions rods of specific length because it is adjustible. Sizing becomes quick and easy.

Still another object is to provide a single tension rod that provides for a more simplistic drum building or repair process.

A further object is to provide a single tension rod that can reduce drum manufacturing costs.

Yet another object is to provide a single tension rod that simplifies tension rod inventory.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the tension snap-rod of the present invention;

FIG. 2 is a side view in elevation thereof, with the threads removed so as to highlight the groove portion;

FIG. 3 is a detailed side view in elevation showing the grooves allowing for damage free snap-off of an unwanted portion of the tension snap-rod; and

FIG. 4 is a top plan view thereof.

### DETAILED DESCRIPTION OF THE INVENTION

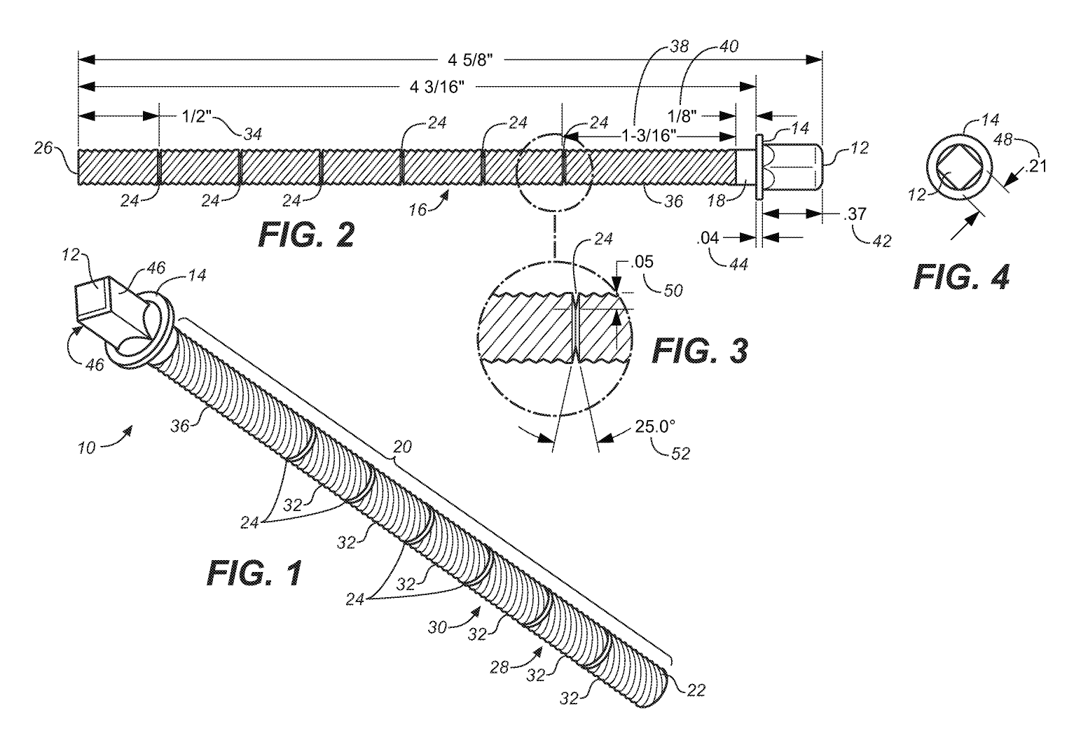

Referring to FIGS. 1 through 4, wherein like reference numerals refer to like components in the various views, there is illustrated therein a new and improved adjustable length acoustic drum hardware tension rod (“tension snap-rod”), generally denominated 10 herein.

FIGS. 1-4 illustrate a preferred embodiment of the inventive tension snap-rod 10, showing that it resembles conventional drum tension rods suitable for securing a hoop to a drum lug. The tension snap-rod of the present invention thus includes a hex head 12 and flange 14, and a shaft 16 having a small shoulder portion 18 immediately below the flange and a threaded portion 20 having external (male) threads 22. Along the length of the threaded portion a plurality of grooves 24 are cut into the threads and the shank 26 of the shaft, each groove creating a discontinuity in the thread run. The grooves, however, do not disrupt the smooth and continuous threading of the tension rod into a female lug having complementary grooves, insofar as the terminal portion of the continuous thread of a groove on a lower portion 28 of the threaded shaft is helically aligned with the beginning portion of the thread on the immediately adjacent upper portion 30.

All thread dimensions (threads per inch, pitch, thread profile, thread depth, etc.) are maintained as if the thread were entirely continuous. In effect, the groove is simply the physical realization of a “disappeared” or cut-out portion of the thread. Thus, when the tension rod is left intact, the smooth and uninterrupted threaded insertion into a lug will not be disrupted. When one or more of the segments of the tension rod are snapped off, the lowermost portion will still insert smoothly into a lug and rotation of the rod beyond the distal-most portion will continue to more proximal portions because the threads are merely gapped or discontinuous, but they remain in helical alignment and are not displaced.

Preferred dimensions of the various tension rod elements include threaded distal segments 32 of approximately ½ inch in length each (˜12 mm) 34, a threaded proximal segment 36 of approximately 1 3/16 inches (˜20 mm) 38; a shoulder portion 18 of approximately ⅛ inch (˜3 mm) 40; a head 12 of approximately 0.37 inches (˜9.4 mm) 42; a flange 14 of approximately 0.04 inches (˜1 mm) 44; opposing hex head sides 46 spaced apart at about 0.21 inches (˜5.3 mm) 48; and grooves 24 of about 0.05 inches (˜1.3 mm) and having sides 50 pitched at approximately 25 degrees 52.

In a method of using the above-described adjustable tension rod, when one or more threaded distal segments need to be removed to size the tension rod for a drum where the reach from a hoop to a mounting lug is shorter than the length of the existing rod, a nut may be threaded onto the rod and rotated to a position immediately above the groove immediately above the portion(s) to be removed (thus becoming a “terminal groove”). A pliers or wrench or other grasping tool may be installed on the terminal portion of the rod and the distal portions snapped off at the terminal groove. The remaining threaded portion is protected from damage both by the nut installed and by the clean break enabled by the groove, which weakens the shank sufficiently to focus the break at the desired point.

It will be appreciated, therefore, that in its most essential aspect, the inventive article of manufacture is an adjustable length tension rod for acoustic drums that has a head for turning the rod with a tool, a flange, a shaft having a shoulder portion below the flange, a shank extending from the flange and having external threads defining a thread run and creating a threaded portion, and a plurality of spaced-apart grooves along the length of the threaded portion and cut through the threads and partly into the shank so as to created threaded segments, each of the grooves creating a discontinuity in the thread run, such that the external threads of adjoining threaded segments remain helically aligned over the discontinuities.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. For instance, those with skill will appreciate that the head of the tension rod, rather than being a hex head, may be provided as a socket cap

Therefore, the above description and illustrations should not be construed as limiting the scope of the invention, which is defined by the appended claims.

What is claimed as invention is:

1. An adjustable length tension rod for acoustic drums, comprising:
A head for turning the tension rod with a tool;
a shaft having a shoulder portion and a threaded portion having external threads defining a thread run;
a flange disposed between said head and said shaft; and
a plurality of spaced apart grooves along the length of said threaded portion cut into the threads and partly into said shank so as to created threaded segments, each of said grooves creating a discontinuity in said thread run, wherein said external threads of adjoining threaded segments remain helically aligned over the discontinuities.

2. The adjustable length tension rod of claim 1, wherein all dimensions of said external threads are maintained over the entire length of said threaded portion.

3. The adjustable length tension rod of claim 2, wherein said thread dimensions include threads per inch, thread pitch, thread profile, and thread depth.

4. The adjustable length tension rod of claim 1, wherein said head is a hex head.

5. A segmented tension rod for a drum, comprising:
an elongate shaft having threads disposed along substantially all of its length;
a plurality of V-shaped grooves cut into said threads and into a portion of said shank so as to weaken said shank at said grooves and to define a plurality of threaded segments on said shaft;
a head configured for use with a turning tool to turn said tension rod to tighten and loosen it selectively in a mounting lug on a drum; and
a flange disposed between said shaft and said head for seating on a drum hoop.

6. The segmented tension rod of claim 5, wherein said grooves are cut entirely through said threads and partly into said shaft.

7. The segmented tension rod of claim 6, wherein said grooves are generally evenly spaced apart.

8. The segmented tension rod of claim 6, including a plurality of distal threaded segments of substantially equal length.

9. The segmented tension rod of claim 8, wherein said distal threaded segments are approximately ½ inch in length.

10. The segmented tension rod of claim 9, further including a proximal threaded segment having a length greater than that of said distal threaded segments.

11. The segmented tension rod of claim 10, wherein said proximal threaded segment is approximately 1 3/16 inches in length.

12. The segmented tension rod of claim 5, wherein said tension rod has a total length greater than 4 inches.

13. The segmented tension rod of claim 5, wherein the depth of said grooves is approximately 0.05 inches.

14. The segmented tension rod of claim 13, wherein said grooves are cut with a pitch of approximately 25 degrees.

15. The segmented tension rod of claim 5, wherein said grooves are cut with a pitch of approximately 25 degrees.
